(19) United States
(12) Patent Application Publication
(10) Pub. No.: US 2022/0083711 A1
(43) Pub. Date: Mar. 17, 2022

(54) EFFECTIVE CHAIN-TYPE CVT DYNAMICS ANALYZING METHOD

(71) Applicant: VIRTUALMOTION INC., Seoul (KR)

(72) Inventors: Hui Je CHO, Uiwang (KR); Chul Ho LEE, Yongin (KR); Dong Hee BAE, Seoul (KR); Sul Ki SEONG, Anyang (KR)

(21) Appl. No.: 17/290,733

(22) PCT Filed: Dec. 21, 2018
(86) PCT No.: PCT/KR2018/016470

§ 371 Date: Nov. 29, 2021

(30) Foreign Application Priority Data
Nov. 2, 2018 (KR) 10-2018-0133824

(51) Int. Cl. G06F 30/23; F16H 57/01

(52) U.S. Cl. CPC G06F 30/23; G06F 2119/14; F16H 57/01

(57) ABSTRACT

An effective chain-type CVT dynamic analysis method according to the present invention is capable of extracting stiffness data and deformation amount for each position from the pulley configuring in a flexible body and inputting into the pulley of the continuously variable transmission (CVT) system configuring in a rigid body to quickly and accurately calculate the deformation of the pulley due to contact with the pins of the chain.

### TECHNICAL FIELD

An effective chain-type CVT dynamic analysis method according to the present invention includes a pulley stiffness analysis step for calculating the influence of stiffness of a point located around a point in which the stiffness data is measured when measuring the stiffness data of a pulley configuring in a flexible body, a system model configuration step of configuring a model of a continuously variable transmission based on multi-body dynamics, a stiffness data application step of mapping data calculated in the pulley stiffness analysis step for each position of the pulley configured in the system model configuration step, and an analysis result calculation step of calculating the deformation amount of the pulley due to the contact with a chain pin of a continuously variable transmission, capable of extracting stiffness data and deformation amount for each position from the pulley configuring in a flexible body and inputting into the pulley of the continuously variable transmission (CVT) system configuring in a rigid body to quickly and accurately calculate the deformation of the pulley due to contact with the pins of the chain.

### DISCUSSION OF RELATED ART

A continuously variable transmission (CVT) is a transmission that can control the gear ratio in a step close to infinity within a predetermined range, and a chain-type CVT is configuring in a chain and a pulley to transmit power by frictional forces of both.

In general, analysis of such a continuously variable transmission is done by a method of predicting dynamic characteristics or performance by configuring an entire continuously variable transmission in a system, and deformation of the pulley generated by the contact between the pulley and the pin of the chain affects the dynamic characteristic of the system and is a factor that should be considered in system analysis.

In the related art, in an analysis method in consideration of the dynamic characteristics of the continuously variable transmission as described above, the following methods have been used.

First, there was a method of configuring an entire model of a continuously variable transmission system based on a rigid body to perform multi-body dynamics analysis. Such a method expresses the deformation of the pulley by the amount of penetration generated by the contact between the pulley and the pins of the chain, the degree of freedom of the object is lower than that of the flexible body, so that the analysis time is fast, however the dynamic characteristics of the system are not reflected, so that accuracy has been lowered.

Second, there was a method of performing multi-body dynamics analysis by configuring an entire system of continuously variable transmission in a flexible body. Such a method was able to confirm the dynamic characteristics of the CVT system by considering a deformation amount of the pulley, and to obtain an accurate analysis result. However, due to the characteristics of the flexible body analysis, the degree of freedom increased, so that an analysis time has been increased exponentially. In particular, in the case of a model that rotates quickly, such as CVT, there has been many analysis steps, so that, such an analysis time problem was exacerbated.

Third, there was a flexible body analysis method in consideration of a mode deformation of the pulley. Such a method is a method of using a model in consideration of the deformation caused by the mode of pulley for solving the degree of freedom in the second method to perform multi-body dynamics analysis. Prior to the mode deformation analysis according to the frequency of vibration of normal mode, each deformation information was defined and analyzed in advance, so that the deformation of the pulley was reflected and the degree of freedom could be solved dramatically to improve the analysis efficiency. However, when there was no deformation mode due to contact with the pin, there has been a problem that leaded to incorrect analysis results. In order to prevent this, repetitive mode analysis was required, and when a large number of modes had to be calculated, there has been a disadvantage in that an increase in analysis time occurred as in the second method.

Due to such problems of the conventional methods, a necessity for an analysis method capable of accurately and quickly calculating a result reflecting the dynamic characteristics of the CVT system in consideration of the recent pulley deformation is emerging.

### SUMMARY OF DISCLOSURE

### Technical Problem

The present invention is directed to solving the above problems, and an embodiment provides an effective chain-type CVT dynamic analysis method, capable of extracting stiffness data and deformation amount for each position from a pulley configuring in a flexible body and inputting into a pulley of a continuously variable transmission (CVT) system configuring in a rigid body to quickly and accurately calculate deformation of the pulley due to contact with a pin.

Another embodiment provides an efficient chain-type CVT dynamic analysis method, including the pulley stiffness analysis step of calculating the influence of stiffness of a point located around the point in which stiffness data is measured when the stiffness data of the pulley configuring in the flexible body is measured, capable of implementing local transformation generated in the pulley.

Still another embodiment provides an effective chain-type CVT dynamic analysis method, in which the pulley stiffness analysis step includes a flexible body configuration step of configuring the pulley to be subjected to stiffness analysis in a flexible body, an analysis reference point setting step of setting an analysis reference point that is a reference point for analysis on the pulley, a stiffness analysis performing step of applying a load to each analysis reference point to perform stiffness analysis, a stiffness data extraction step of extracting load data according to a displacement of the analysis reference point to which the load is applied, and a deformation amount data extraction step of calculating the influence according to a stiffness of the point around the analysis reference point to which the load is applied, capable of performing flexible analysis according to accuracy of the required analysis, difficulty of analysis, and user's convenience or the like, and calculating stiffness data and flexible body data via separate flexible body model, thereby performing quick and accurate analysis.

Still another embodiment provides an effective chain-type CVT dynamic analysis method, in which the analysis reference point is setting in plural at predetermined intervals along a radial direction, a circumferential direction, or both directions of the pulley and setting a point to be a reference point for analysis in multiple directions, capable of flexibly adjusting accuracy of analysis, time required for analysis, difficulty of analysis or the like.

Still another embodiment provides an effective chain-type CVT dynamics analysis method, in which in the deformation amount data extraction step, the deformation amount according to a stiffness of the point located in a circumferential direction based on the analysis reference point to which the load is applied is calculated, capable of reflecting an actual deformation amount of pulley due to contact with the chain pin and pulley.

Still another embodiment provides an effective chain-type CVT dynamic analysis method, further including a system model configuration step of configuring a model of the continuously variable transmission based on the multi-body dynamics, a stiffness data application step of mapping data calculated in the pulley stiffness analysis step for each position of the pulley configured in the system model configuration step, and an analysis result calculation step of calculating the deformation amount of the pulley due to the contact with a chain pin of a continuously variable transmission, capable of implementing the stiffness analysis performing step and multi-body dynamics analysis performing step in a separate modeling environment to rapidly and accurately analyze entire system.

Still another embodiment provides an effective chain-type CVT dynamic analysis method, in which the stiffness data application step is such that the stiffness data and deformation amount data of the analysis reference point calculated in the stiffness analysis step are mapped to a point corresponding to the analysis reference point, capable of implementing multi-body dynamic analysis in a state in which stiffness is mapped.

Still another embodiment provides an effective chain-type CVT dynamics analysis method, in which in the analysis result calculation step, the deformation amount of the pulley generated around the analysis reference point is added and calculated, capable of reflecting the deformation amount of pulley generated around the point to which a load is applied to the analysis result.

Still another embodiment provides an effective chain-type CVT dynamics analysis method, in which, in the analysis result calculation step, the deformation amount of the pulley according to a position on a circumferential direction based on the analysis reference point is added and calculated, capable of reflecting deformation amount of pulley generated at a point located on a circumferential direction of the point in which the load is applied to the analysis result.

### Technical Solution

The present invention is implemented by an embodiment having the following configuration in order to achieve the above object.

According to one embodiment of the present invention, and the present invention is such that stiffness data and deformation amount for each position from a pulley configuring in a flexible body is extracted and input into a pulley of a continuously variable transmission (CVT) system configuring in a rigid body to quickly and accurately calculate deformation of the pulley due to contact with a pin.

According to another embodiment of the present invention, the present invention includes a pulley stiffness analysis step of calculating the influence of stiffness of a point located around the point in which stiffness data is measured when the stiffness data of the pulley configuring in the flexible body is measured.

According to still another embodiment of the present invention, the present invention is characterized in that the pulley stiffness analysis step includes a flexible body configuration step of configuring the pulley to be subjected to stiffness analysis in a flexible body, an analysis reference point setting step of setting an analysis reference point that is a reference point for analysis on the pulley, a stiffness analysis performing step of applying a load to each analysis reference point to perform stiffness analysis, a stiffness data extraction step of extracting load data according to a displacement of the analysis reference point to which the load is applied, and a deformation amount data extraction step of calculating the influence according to a stiffness of the point around the analysis reference point to which the load is applied.

According to still another embodiment of the present invention, the present invention is characterized in that the analysis reference point is set in plural at predetermined intervals along a radial direction of the pulley.

According to still another embodiment of the present invention, the present invention is characterized in that the analysis reference point is set in plural at predetermined intervals along a circumferential direction of the pulley.

According to still another embodiment of the present invention, the present invention is characterized in that, in the deformation amount data extraction step, the deformation amount according to a stiffness of the point located in a circumferential direction based on the analysis reference point to which the load is applied is calculated.

According to another embodiment of the present invention, the present invention is characterized in that the effective chain-type CVT dynamics analysis method further includes a system model configuration step of configuring a model of a continuously variable transmission based on multi-body dynamics, a stiffness data application step of mapping the calculated in the pulley stiffness analysis step for each position of the pulley configured in the system model configuration step, and an analysis result calculation step of calculating the deformation amount of the pulley due to the contact with a chain pin of a continuously variable transmission.

According to still another embodiment of the present invention, the present invention is characterized in that, in the stiffness data application step, the stiffness data and deformation amount data of the analysis reference point calculated in the stiffness analysis step are mapped to a point corresponding to the analysis reference point.

According to still another embodiment of the present invention, the present invention is characterized in that the stiffness data application step is such that the stiffness data and the deformation amount data of the analysis reference point located in the same radial direction are mapped in plural at predetermined intervals along a circumferential direction with respect to a center of the pulley.

According to still another embodiment of the present invention, the present invention is characterized in that, in the analysis result calculation step, the deformation amount of the pulley generated around the analysis reference point is added and calculated.

According to still another embodiment of the present invention, the present invention is characterized in that, in the analysis result calculation step, the deformation amount of the pulley according to a position on a circumferential direction based on the analysis reference point is added and calculated.

### Advantageous Effects

The present invention may have the following advantageous effects according to the configuration, combination, and use relationship described above with respect to the present embodiment.

The present invention derives an effect such that stiffness data and deformation amount for each position from a pulley configuring in a flexible body is extracted and input into a pulley of a continuously variable transmission (CVT) system configuring in a rigid body, thereby quickly and accurately calculating deformation of the pulley due to contact with a pin.

The present invention derives an effect such that the pulley stiffness analysis step of calculating the influence of stiffness of a point located around the point which stiffness data is measured when the stiffness data of the pulley configuring in the flexible body is measured is included, thereby implementing local transformation that occurs in the pulley.

The present invention derives an effect such that the pulley stiffness analysis step includes a flexible body configuration step of configuring the pulley to be subjected to stiffness analysis in a flexible body, an analysis reference point setting step of setting an analysis reference point that is a reference point for analysis on the pulley, a stiffness analysis performing step of applying a load to each analysis reference point to perform stiffness analysis, a stiffness data extraction step of extracting load data according to a displacement of the analysis reference point to which the load is applied, and a deformation amount data extraction step of calculating the influence according to a stiffness of the point around the analysis reference point to which the load is applied, capable of performing flexible analysis according to accuracy of the required analysis, difficulty of analysis, and user's convenience or the like, and calculating stiffness data and flexible body data via separate flexible body model, thereby performing quick and accurate analysis.

The present invention derives an effect such that the analysis reference point is setting in plural at predetermined intervals along a radial direction, a circumferential direction, or both directions of the pulley and setting a point to be a reference point for analysis in multiple directions, thereby flexibly adjusting accuracy of analysis, time required for analysis, difficulty of analysis or the like.

The present invention derives an effect such that, in the deformation amount data extraction step, the deformation amount according to a stiffness of the point located in a circumferential direction based on the analysis reference point to which the load is applied and calculated, thereby reflecting an actual amount of pulley deformation due to contact with the chain pin and pulley.

The present invention derives an effect such that the system model configuration step of configuring a model of the continuously variable transmission based on the multi-body dynamics, a stiffness data application step of mapping data calculated in the pulley stiffness analysis step for each position of the pulley configured in the system model configuration step, and an analysis result calculation step of calculating the deformation amount of the pulley due to the contact with a chain pin of a continuously variable transmission are further included, and the stiffness analysis performing step and multi-body dynamics analysis performing step in a separate modeling environment is implemented, thereby rapidly and accurately analyzing an entire system.

The present invention derives an effect such that the stiffness data application step is such that the stiffness data and deformation amount data of the analysis reference point calculated in the stiffness analysis step are mapped to a point corresponding to the analysis reference point, thereby implementing multi-body dynamic analysis in a state in which stiffness is mapped.

The present invention derives an effect such that, in the analysis result calculation step, the deformation amount of the pulley generated around the analysis reference point is added and calculated, thereby reflecting the deformation amount of pulley generated around the point to which a load is applied to the analysis result.

The present invention derives an effect such that, in the analysis result calculation step, the deformation amount of the pulley according to a position on a circumferential direction based on the analysis reference point is added and calculated, thereby reflecting deformation amount of pulley generated at the point located on a circumferential direction of the point to which the load is applied in the analysis result.

### DESCRIPTION OF DRAWINGS

FIG. 1 is a diagram of an effective chain-type CVT dynamic analysis method according to an embodiment of the present invention.

FIG. 2 is a diagram of a pulley stiffness analysis step according to another embodiment of the present invention.

FIG. 3 is a diagram of another analysis reference point setting step according to still another embodiment of the present invention.

FIG. 4 is a graph illustrating stiffness according to a position of an analysis reference point according to still another embodiment of the present invention.

FIG. 5 is a graph illustrating a deformation ratio in a circumferential direction of an analysis reference point according to still another embodiment of the present invention.

FIG. 6 is a graph illustrating a deformation amount of a pulley according to a position of the analysis reference point calculated in the analysis result calculation step according to still another embodiment of the present invention.

### DETAILED DESCRIPTION OF EXEMPLARY EMBODIMENTS

Hereinafter, preferred embodiments of an effective chain-type CVT dynamic analysis method according to the present invention will be described in detail with reference to the accompanying drawings. In the following description of the present disclosure, when detailed description of a known function or configuration is deemed to unnecessarily blur the gist of the present disclosure, the detailed description will be omitted. Unless otherwise specified, all terms in this specification are the same as the general meaning of the term understood by a person skilled in the art to which the present invention belongs, and when there is a conflict with the meaning of the term used in the present specification, it follows the definition used in the specification.

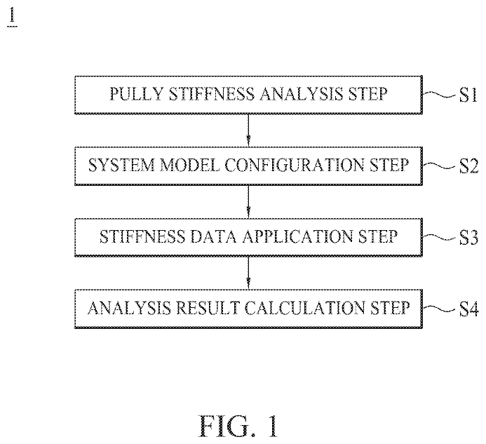

FIG. 1 is a diagram of an effective chain-type CVT dynamic analysis method according to an embodiment of the present invention.

An effective chain-type CVT dynamic analysis method (hereinafter referred to as an analysis method) according to the present invention may be performed by a CVT dynamics analysis system, and includes a pulley stiffness analysis step S1, a system model configuration step S2, a stiffness data application step S3, and an analysis result calculation step S4.

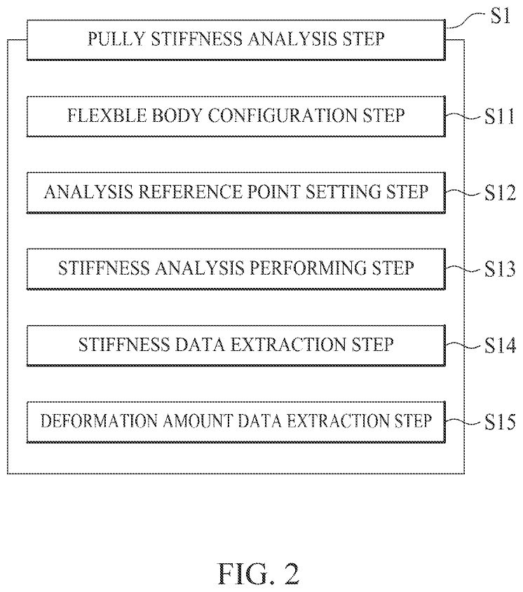

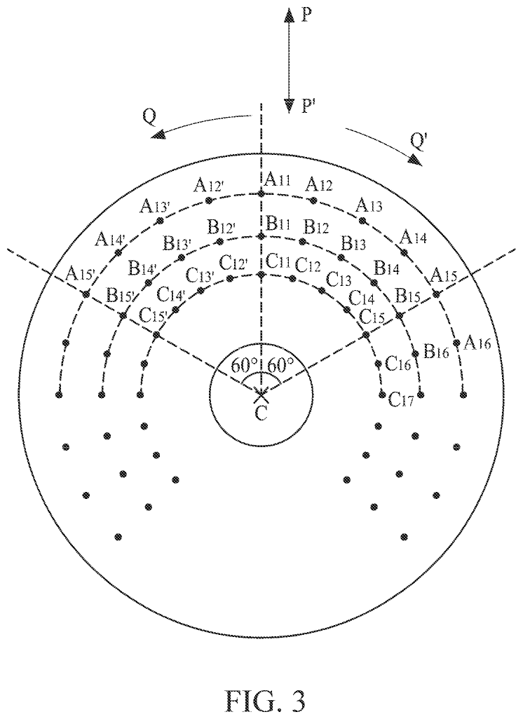

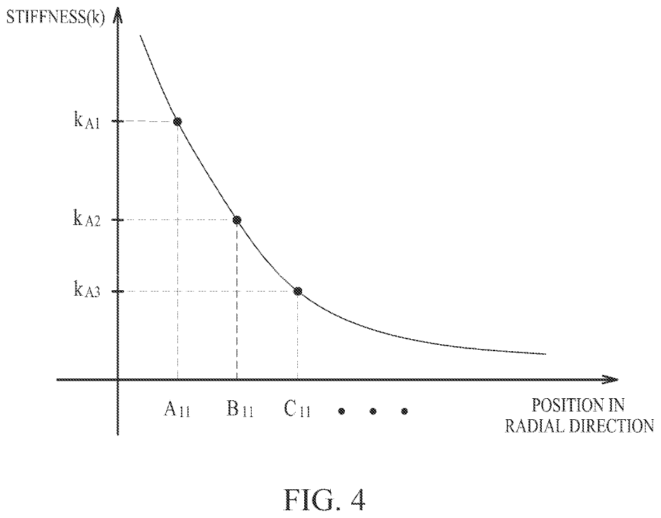

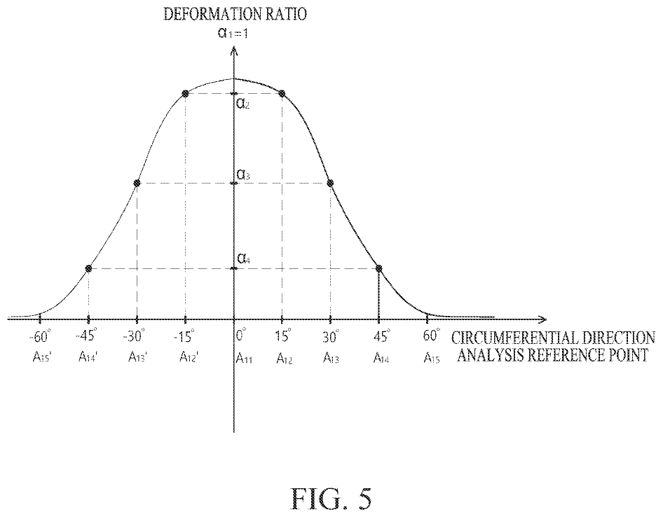

FIG. 2 is a diagram of a pulley stiffness analysis step according to another embodiment of the present invention, FIG. 3 is a diagram of another analysis reference point setting step according to still another embodiment of the present invention, FIG. 4 is a graph illustrating stiffness according to a position of an analysis reference point according to still another embodiment of the present invention, and FIG. 5 is a graph illustrating a deformation ratio in a circumferential direction of an analysis reference point according to still another embodiment of the present invention.

Hereinafter, a radial direction P-P′ refers to a direction in a straight line extending from a center of the pulley to an outside of the pulley, and a circumferential direction Q-Q′ refers to a direction of maintaining a predetermined distance from a center of the pulley and drawing a circle along a circumference of the pulley.

The pulley stiffness analysis step S1 is a step of configuring the pulley to be analyzed in a flexible body, and then calculating a stiffness value and a deformation amount according to a position of the pulley to be input to the pulley on the system model configured based on the multi-body dynamics.

As shown in FIG. 2, the pulley stiffness analysis step S1 further includes a flexible body configuration step S11, an analysis reference point setting step S12, a stiffness analysis performing step S14, a stiffness data extraction step S14, and a deformation amount data extraction step S15.

The flexible body configuration step S11 is a step of configuring the pulley to be subjected to the stiffness analysis with a flexible body for the stiffness analysis performing step S14 to be performed later.

The analysis reference point setting step S12 is a step of setting an analysis reference point that is a reference for analysis on the pulley. The analysis reference point may be regarded as a point in which the analysis for calculating the stiffness data and the deformation amount data is necessary among the points in which the pins constituting the chain of the CVT system is in contact with the pulley. The analysis reference point may be a plurality of any points on the pulley to be analyzed, and the setting may be different depending on required accuracy of analysis and analysis time, user setting, convenience of analysis, and the like. Preferably, as shown in FIG. 3, the analysis reference point may be set as a node on a grid forming predetermined intervals along a radial direction P-P′ and circumferential direction Q-Q′ of the pulley. More preferably, as shown in FIG. 3, the analysis reference point may be some nodes A11, B11, C11, and the like located on the same radial direction P-P′ among nodes on the grid.

Since this is because a shape of a general pulley has a symmetrical shape with respect to a center of the pulley, the stiffness data and deformation data measured at analysis reference points A11, B11, C11, and the like located on the same radial direction P-P′ may be mapping equally at predetermined intervals with respect to a center of the pulley in the stiffness data application step S3 to be described later, so that interpretation of other positions on the pulley may be omitted. That is, an entire analysis process via the analysis using the symmetry of the pulley may be simplified and analysis time may be reduced.

However, the setting of the analysis reference point is only an example, and various setting methods such as setting the analysis reference point or the like in a grid format at predetermined intervals throughout all surfaces on the pulley may be performed.

The stiffness analysis performing step S14 is a step of applying a load in a vertical direction to the analysis reference point to perform a stiffness analysis. Preferably, the stiffness analysis may be performed by using a flexible body-based finite element analysis (FEM) or Meshfree.

The stiffness data extraction step S14 is a step of extracting load data according to a displacement of each analysis reference point derived by the stiffness analysis performing step S14. The load data according to the displacement may be calculated in plural depending on the number of analysis reference points in the analysis reference point setting step S12. Preferably, the load data according to the displacement may be calculated in a form of a constant value k, a stiffness matrix such as full matrix or diagonal matrix, or a displacement-load graph as shown in FIG. 4.

The deformation amount data extraction step S15 is a step of calculating a deformation amount of the points around the analysis reference point. Preferably, a deformation amount in a circumferential direction of each analysis reference point located along a radial direction may be calculated in a deformation ratio. As shown in FIG. 3, considering that a pin of the chain of a CVT system is in contact along the circumferential direction Q-Q′ of the pulley, the deformation ratio may be extracted along the circumferential direction Q-Q′ of the analysis reference point. Preferably, as shown in FIGS. 3 and 5, the deformation ratio may be extracted at 15° intervals A11, A12, A13, and the like, A21, A22, A23, and the like, and A31, A32, A33, and the like along a circumferential direction of the analysis reference points A11, A21, A31, and the like, and a circumferential deformation ratios of the analysis reference point A1 may be expressed as α₁, α₂, α₃ to αₙ.

As shown in FIG. 5, the deformation ratio α₁, α₂, α₃ to αₙ is inversely proportional to the distance in the circumferential direction Q-Q′ of the analysis reference point, and in general, when more than 60 degrees along the circumferential direction with respect to a center of a pulley is far away, the deformation ratio α₁, α₂, α₃, αₙ, and the like converges to zero.

The system model configuration step S2 is a step of configuring a continuously variable transmission (CVT) in a system model based on multi-body dynamics. The system model based on multi-body dynamics may include a rigid body, a connection configuration (joint), a load element, and the like, and each pulley and a chain are formed in contact.

The stiffness data application step S3 is a step of mapping the stiffness data and deformation data for each position calculated in the pulley stiffness analysis step S1 to the pulleys of the model configured in the system model configuration step S2. The stiffness data and the deformation amount data of the analysis reference point are mapped to corresponding positions on the pulley configured in the system model configuration step S2. As described above, the stiffness data and the deformation amount may be mapped by using symmetry of the pulley. Preferably, the stiffness data and deformation amount data of the analysis reference point located in the same radial direction are mapped in plural at predetermined intervals along the circumferential direction Q-Q′ with respect to a center of the pulley configured in the system model configuration step S2. More preferably, the stiffness data and deformation amount data of the analysis reference point located in the same radial direction P-P′ are mapped at 15 degree intervals along the circumferential direction Q-Q′ with respect to a center of the pulley configured in the system model configuration step S2.

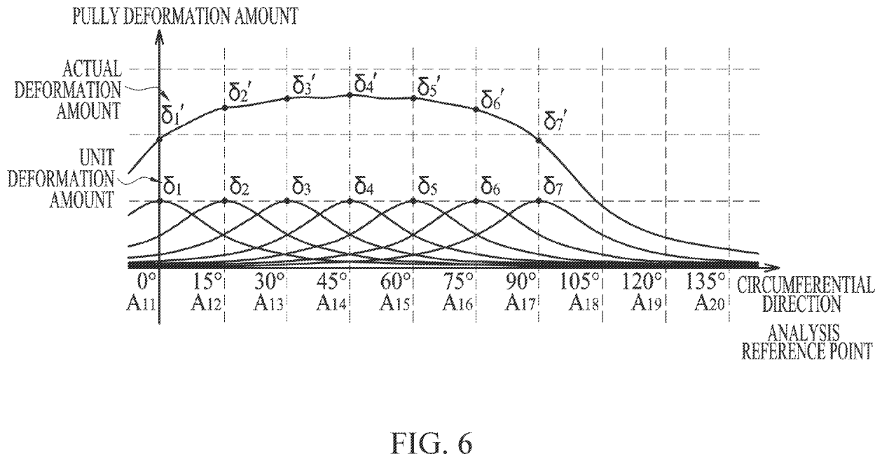

FIG. 6 is a graph illustrating a deformation amount of a pulley according to a position of the analysis reference point calculated in the analysis result calculation step S4 according to still another embodiment of the present invention.

The analysis result calculation step S4 is a step of using the multi-body dynamics model system on which the mapping in the stiffness data application step S3 is reflected to calculate the deformation amount of the pulley due to contact with the chain pins of the CVT. Preferably, the deformation amount of the pulley calculated in the analysis result calculation step S4 may be calculated by reflecting the deformation amount of the pulley generating along the circumferential direction Q-Q′ based on the analysis reference point. More preferably, the deformation amount of the pulley calculated in the analysis result calculation step S4 may be calculated by reflecting the deformation amount along the circumferential direction of another analysis reference point located on the same circumferential direction Q-Q′ based on the analysis reference point.

Hereinafter, a process of calculating the actual deformation amount of the pulley by reflecting the deformation amount according to the circumferential deformation ratio of each analysis reference point will be described as an example.

In the configuration of the actual CVT, the points in which the chain pins come into contact with the pulley exist in plural at predetermined intervals along the circumferential direction Q-Q′ of the pulley, and accordingly, the actual deformation amount at any contact points is calculated by adding the deformation amount in the circumferential direction of the neighboring contact points.

When described with reference to FIG. 3, each point A12 to An marked in a circumferential direction of the analysis reference point A11 represents points to which the load is applied onto the pulley or points in contact with the chain pin, and is located at 15 degree intervals along a circumferential direction with respect to a center of the pulley.

For example, when a load is applied to point 1 A11 on the pulley, the deformation amount at that point (δ₁, hereinafter referred to as ‘unit deformation amount’) may be expressed as

$${δ}_{1 =} \frac{F}{{k}_{1}}$$

(F is the magnitude of the load, and k₁ is the stiffness value measured at point 1).

In the same manner, when a load is applied to the remaining points A12 to An on the pulley, the unit deformation amount at the remaining points A12 to An may also be expressed as each

$${δ}_{2 =} \frac{F}{{k}_{2}} , {δ}_{3 =} \frac{F}{{k}_{3}} … , {δ}_{7 =} \frac{F}{{k}_{7}} .$$

As described above, k1 to k7 representing the stiffness values may be values derived in the stiffness data extraction step S14 of the pulley stiffness analysis step S1 and have different values depending on a setting of the analysis reference point, user's designation, or the like in the analysis reference point setting step S12 respectively but be used by commonly by using the symmetry of the pulley to apply the stiffness value (k1=k2 to=kn=k) calculated at one analysis reference point A11.

On the other hand, the actual deformation amount at any contact points on the pulley is calculated by reflecting the deformation amount or the deformation ratio α₁, α₂, α₃ to αn in the circumferential direction of neighboring contact points.

Accordingly, when a load is applied from points 1 A11 to point 7 A11 on the pulley, when an is the deformation ratio according to the position on the circumferential direction of the analysis reference point A11 calculated in the pulley stiffness analysis step S1, the deformation amount (δ₁′, hereinafter referred to as ‘actual deformation amount)’) at point 1 in consideration of the deformation ratio in the circumferential direction of each analysis reference point becomes

δ₁′=δ₁×α₁+δ₂×α₂+ . . . +δ₇×α₇_{_{(α1=1)}}.

However, the contact points of the chain pins marked as the analysis reference points of FIG. 3 may be located at 15 degree intervals along a circumferential direction with respect to a center of the pulley, and in general, considering that the load at a point more than 60 degrees away from the reference point A11 in a circumferential direction is not influence on the deformation amount of the reference point, the actual deformation amount at point A11 may be δ₁′=δ₁×α₁+δ₂×α₂+ . . . +δ₅×α₅ excluding after 6th deformation amount.

In the same manner, the actual deformation amount δ₂′, δ₃′ to δ₇′ may be calculated for each of the remaining analysis reference points A12, A13, A14 to A17, and this may be expressed as a graph shown in FIG. 6.

As a result, in the same manner as above, the deformation amount of the pulley due to contact with the chain pin for the remaining analysis reference points B11, B12, B13, and the like and C11, C12, C13, and the like on the pulley may be calculated, and the entire deformation amount of the pulley due to contact with the chain pin based on the amount of deformation at each analysis reference point may be calculated.

The foregoing detailed description illustrates the present invention. In addition, the foregoing is intended to illustrate and describe the preferred embodiments of the invention and the invention may be utilized in various other combinations, modifications and environments. That is, it is possible to make changes or modifications within the scope of the concept of the invention disclosed herein, within the scope of equivalents to the above-described disclosure, and/or within the skill and knowledge of the art. The above-described embodiments are intended to describe the best mode for carrying out the technical spirit of the present invention and various modifications required in the specific applications and uses of the present invention are possible. Accordingly, the foregoing detailed description is not intended to limit the invention to the embodiments disclosed. Also, the appended claims should be understood to include other embodiments.

### INDUSTRIAL APPLICABILITY

The present invention relates to a chain-type CVT dynamics analysis method and is applicable to a simulation analysis method for components in the automobile industry, etc.

1. An effective chain-type CVT dynamic analysis method, performed by a CVT dynamics analysis system, and extracting stiffness data and deformation amount for each position from a pulley configuring in a flexible body and inputting into a pulley of a continuously variable transmission (CVT) system configuring in a rigid body to quickly and accurately calculate deformation of a pulley due to contact with a pin, comprising:
a pulley stiffness analysis step of calculating the influence of stiffness of a point located around the point in which stiffness data is measured when the stiffness data of the pulley configuring in the flexible body is measured,
wherein the pulley stiffness analysis step comprises:
a flexible body configuration step of configuring the pulley to be subjected to stiffness analysis in a flexible body,
an analysis reference point setting step of setting an analysis reference point that is a reference point for analysis on the pulley,
a stiffness analysis performing step of applying a load to each of the analysis reference point to perform stiffness analysis,
a stiffness data extraction step of extracting load data according to a displacement of the analysis reference point to which the load is applied, and
a deformation amount data extraction step of calculating the influence according to a stiffness of the point around the analysis reference point to which the load is applied.

2. The method of claim 1,
wherein the analysis reference point is set in plural at predetermined intervals along a radial direction of the pulley.

3. The method of claim 2,
wherein the analysis reference point is set in plural at predetermined intervals along a circumferential direction of the pulley.

4. The method of claim 1, wherein, in the deformation amount data extraction step, the deformation amount according to a stiffness of the point located in a circumferential direction based on the analysis reference point to which the load is applied is calculated.

5. The method of claim 1, wherein the effective chain-type CVT dynamics analysis method performed by a CVT dynamics analysis system further comprises:
a system model configuration step of configuring a model of a continuously variable transmission based on multi-body dynamics,
a stiffness data application step of mapping data calculated in the pulley stiffness analysis step for each position of the pulley configured in the system model configuration step, and
an analysis result calculation step of calculating the deformation amount of the pulley due to the contact with a chain pin of a continuously variable transmission.

6. The method of claim 5, wherein, in the stiffness data application step, the stiffness data and deformation amount data of the analysis reference point calculated in the stiffness analysis step are mapped to a point corresponding to the analysis reference point.

7. The method of claim 6, wherein, in the stiffness data application step, the stiffness data and the deformation amount data of the analysis reference point located in the same radial direction are mapped in plural at predetermined intervals along a circumferential direction with respect to a center of the pulley.

8. The method of claim 5, wherein, in the analysis result calculation step, the deformation amount of the pulley generated around the analysis reference point is added and calculated.

9. The method of claim 8, wherein, in the analysis result calculation step, the deformation amount of the pulley according to the position on a circumferential direction based on the analysis reference point is added and calculated.

10. (canceled)

11. (canceled)
